(19) United States
(12) Patent Application Publication
(10) Pub. No.: US 2025/0323708 A1
(43) Pub. Date: Oct. 16, 2025

(54) ACTIVE BEAM PATTERN INFORMATION IN WIRELESS NETWORK

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US); Hongbo Si, Allen, TX (US)

(21) Appl. No.: 19/169,979

(22) Filed: Apr. 3, 2025

Related U.S. Application Data
(60) Provisional application No. 63/632,911, filed on Apr. 11, 2024.
(60) Provisional application No. 63/660,002, filed on Jun. 14, 2024.
(60) Provisional application No. 63/662,799, filed on Jun. 21, 2024.
(60) Provisional application No. 63/682,605, filed on Aug. 13, 2024.
(60) Provisional application No. 63/728,961, filed on Dec. 6, 2024.

(51) Int. Cl. H04B 7/06; H04W 36/36; H04W 64/00

(52) U.S. Cl. CPC H04B 7/06952; H04W 36/362; H04W 64/003

(57) ABSTRACT

A user equipment (UE) capable of facilitating communications in a wireless system can include a processor. In some examples, the processor is to receive from a base station (BS) active beam pattern information associated with a cell. The active beam pattern information can include one or more beams, geographic information, or timing information. In such examples, the processor can also identify a beam status associated with a geographic location of the UE based on the active beam pattern information. In at least one example, the processor can further perform a measurement operation on the cell based on the beam status.

### CROSS-REFERENCE TO RELATED APPLICATIONS

This application claims the benefit of priority from U.S. Provisional Application No. 63/632,911 entitled “ACTIVE BEAM PATTERN IN NON-TERRESTRIAL NETWORK,” filed Apr. 11, 2024; U.S. Provisional Application No. 63/660,002 entitled “ACTIVE BEAM PATTERN IN NON-TERRESTRIAL NETWORK,” filed Jun. 14, 2024; U.S. Provisional Application No. 63/662,799 entitled “ACTIVE BEAM PATTERN IN NON-TERRESTRIAL NETWORK,” filed Jun. 21, 2024; U.S. Provisional Application No. 63/682,605 entitled “UE CAPABILITY FOR MBS MULTICAST IN NTN,” filed Aug. 13, 2024, and U.S. Provisional Application No. 63/728,961 entitled “ACTIVE BEAM PATTERN IN NON-TERRESTRIAL NETWORK,” filed Dec. 6, 2024, all which are incorporated herein by reference in their entirety.

### TECHNICAL FIELD

This disclosure relates generally to a wireless communication system, and more particularly to, for example, but not limited to, active beam pattern information in a wireless communication system.

### BACKGROUND

Determining geographic areas that could potentially service a device represent a pivotal aspect of any wireless communication system. These systems include, for example, LTE and 5G New Radio (NR), and upcoming technologies currently coined “6G”. Current management of active beam pattern information and geographic areas covered by the active beams in the pattern are presently controlled by the network to maintain optimal connection quality. The network can adjust a pattern of active beams or inactive beams to accommodate traffic demand.

In some systems, the network can only provide a limited number of active beams. When only the network manages the active beam pattern information, a User Equipment (UE) can be forced to constantly monitor active and inactive beams or measure inactive neighboring cells. By constantly monitoring for active and inactive beam patterns, the UE can use additional power.

The description set forth in the background section should not be assumed to be prior art merely because it is set forth in the background section. The background section may describe aspects or embodiments of the present disclosure.

### SUMMARY

An aspect of the present disclosure provides a user equipment (UE) for facilitating communication in a wireless network, the UE comprising: a processor configured to: receive, from a base station (BS), active beam pattern information associated with a cell, wherein the beam pattern information includes one or more beams, geographic information, or timing information; identify a beam status associated with a geographic location of the UE based on the active beam pattern information; and perform a measurement operation on the cell based on the active beam status.

In some embodiments, the one or more beams of the active beam pattern information associated with the cell includes a list of beam indexes comprising the one or more beams, each beam being identified by a respective beam identification (ID).

In at least one embodiment, the processor is further configured to determine an active time and an inactive time of a beam for the geographic location of the UE based on the active beam pattern information.

In some examples, to perform the measurement operation on the cell, the processor is further configured to measure the cell during the active time of the beam and refrain from measuring the cell during the inactive time of the beam.

In some embodiments, the processor is further configured to communicate with the BS during the active time of the beam for the geographic location of the UE and refrain from communicating with the BS during the inactive time of the beam for the geographic location of the UE.

In at least one embodiment, the active beam pattern information is associated with a plurality of frequencies, and wherein one or more beams indicated by the active beam pattern information are associated with a respective frequency of the plurality of frequencies.

In some embodiments, the processor is further configured to determine an active time of the beam for a first frequency of the plurality of frequencies; determine an inactive time of the beam for the first frequency of the plurality of frequencies; prioritize the first frequency for measurement during the active time of the beam; and deprioritize the first frequency for measurement during the inactive time of the beam.

In at least one example, the timing information of the active beam pattern information includes at least one of a periodicity, a duration, or an offset for an active time of a beam associated with the beam pattern information.

In some examples, the geographic information of the active beam pattern information includes at least one of a beam angle, location coordinate, or distance of a beam associated with the active beam pattern information.

In at least some embodiments, the processor is further configured to perform a cell reselection operation or execute a condition handover (CHO) operation based at least in part on performing the measurement operation.

An aspect of the present disclosure provides a base station (BS) for facilitating communication in a wireless network, the BS comprising: a processor configured to: identify a beam status for a geographic location associated with a user equipment (UE); generate an active beam pattern information associated with a cell associated with the UE, wherein the active beam pattern information includes the beam status, one or more beams, geographic information, or timing information; and a transceiver operably coupled to the processor, the transceiver configured to transmit the active beam pattern information to a user equipment (UE) that is used for a measurement operation for the cell based at least in part on generating the active beam pattern information.

In some embodiments, the one or more beams of the active beam pattern information associated with the cell includes a list of beam indexes comprising the one or more beams, each beam being identified by a respective beam identification (ID).

In at least one embodiment, the active beam pattern information is associated with a plurality of frequencies, and one or more beams indicated by the active beam pattern information are associated with a respective frequency of the plurality of frequencies.

In some examples, the timing information of the active beam pattern information includes at least one of a periodicity, a duration, or an offset for an active time of a beam associated with the beam pattern information.

In at least one example, the geographic information of the active beam pattern information includes at least one of a beam angle, location coordinate, or distance of a beam associated with the active beam pattern information.

An aspect of the present disclosure provides a method performed by a user equipment (UE) for facilitating communication in a wireless network, comprising: receiving, from a base station (BS), active beam pattern information associated with a cell, wherein the beam pattern information includes one or more beams, geographic information, or timing information; identify a beam status associated with a geographic location of the UE based on the active beam pattern information; and perform a measurement operation on the cell based on the active beam status.

In at least one embodiment, the one or more beams of the active beam pattern information associated with the cell includes a list of beam indexes comprising the one or more beams, each beam being identified by a respective beam identification (ID).

In some embodiments, the method further comprises determining an active time and an inactive time of a beam for the geographic location of the UE based on the active beam pattern information.

In some examples, where the performing the measurement operation on the cell comprises: measuring the cell during the active time of the beam and refraining from measuring the cell during the inactive time of the beam.

In some embodiments, the method further includes communicating with the BS during the active time of the beams for the geographic location of the UE; and refraining from communicating with the BS during the inactive time of the beam for the geographic location of the UE.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process 400 for utilizing active beam pattern information in accordance with an embodiment.

FIG. 5 shows an example process 500 for performing measurements for a neighboring cell using active beam pattern information in accordance with an embodiment.

FIG. 6 shows an example process 600 for receiving MBS multicast service in an inactive mode in accordance with an embodiment.

FIG. 7 shows an example process 700 for receiving MBS multicast service in a connected mode in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHZ, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (COMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

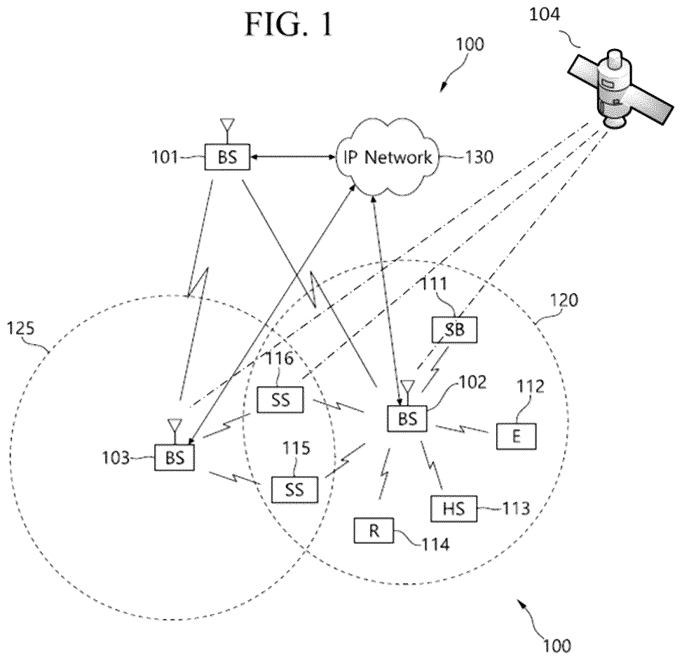

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

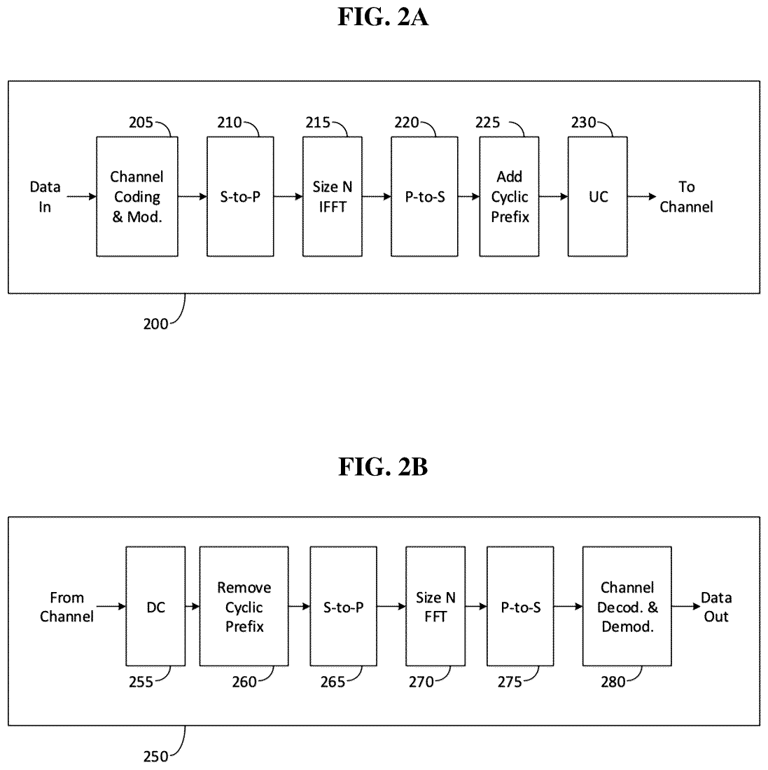

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

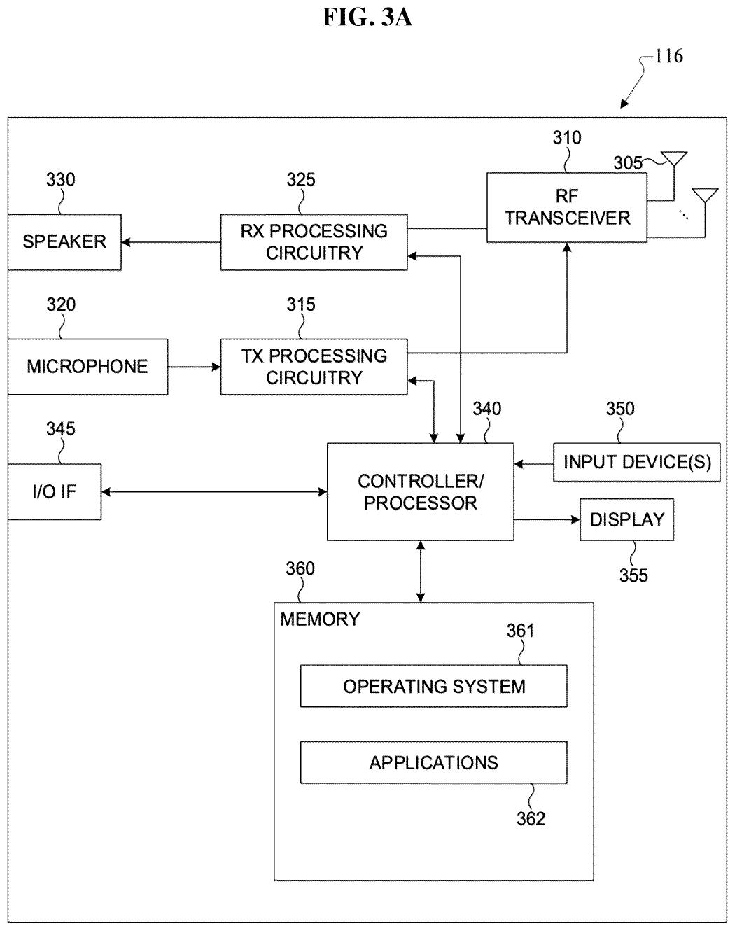

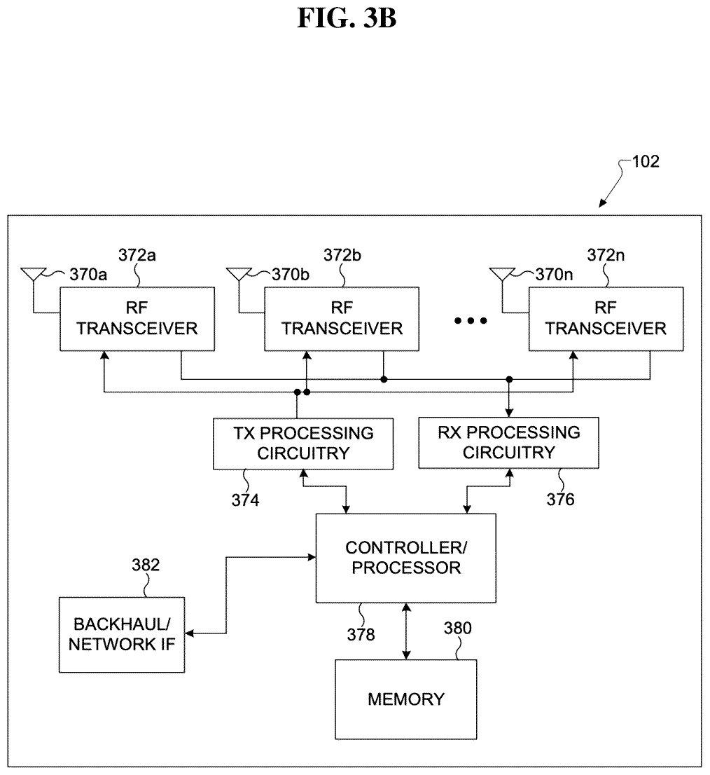

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUS). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure.

The following documents are hereby incorporated by reference in their entirety into the present disclosure as if fully set forth herein: i) 3GPP TS 38.300 v18.1.0; ii) 3GPP TS 38.331 v18.1.0; iii) 3GPP TS 38.321 v18.1.0, iv) 3GPP TS 37.355 v18.1.0; v) 3GPP TS 23.032 v18.1.0; vi) 3GPP TS38.304 v18.2.0; and vii) 3GPP TS 38.306 v18.2.0.

3GPP (Third-Generation Partnership Project) has developed technical specifications and standards to define the new 5G radio-access technology, known as 5G NR (new radio). In Release 17 specifications, the non-terrestrial network (NTN) was introduced as a vertical functionality by 5G NR. In some embodiments, an NTN provides non-terrestrial NR access to a user equipment (UE) by means of, for example and without limitation, an NTN payload (e.g., a satellite) and an NTN Gateway. In at least one embodiment, the NTN payload can receive the radio protocol received from the UE via a service link (e.g., wireless link between the UE and the NTN payload) and transparently forward it to the NTN Gateway via a feeder link (e.g., wireless link between the NTN payload and the NTN Gateway), and vice versa. Given its capabilities of providing wide coverage and reliable service, the NTN is envisioned to ensure service availability and continuity ubiquitously. For example, the NTN can support communication services in unserved areas that are not covered by conventional terrestrial networks, as well as in underserved areas with limited communication services. Additionally, the NTN can support communication services for devices and passengers aboard moving platforms, such as future railway, maritime, or aeronautical communication systems. To support the NTN in 5G NR, various features need to be introduced or enhanced to accommodate the nature of radio access to the NTN, which differs from terrestrial network (TN) in aspects, such as large cell coverage, long propagation delay, and non-static cell/satellite. In at least one embodiment, a cell can refer to a serving cell (e.g., a Primary Cell (PCell), a Primary Secondary Cell (PSCell), or a Secondary Cell (SCell) as defined in TS 38.331).

In at least one embodiment, in the NTN, the NTN payload may be a geosynchronous orbit (GSO) that is an earth-centered orbit at approximately 35,786 kilometers above earth's surface and synchronized with earth's rotation. In another example, the NTN payload may be a non-geosynchronous orbit (NGSO) that is a Low Earth Orbit (LEO) at an altitude approximately between 300 km and 1,500 km or Medium Earth Orbit (MEO) at altitude approximately between 7,000 km and 25,000 km. Depending on different NTN payloads, three types of service links are supported. For example, a first service link is an earth-fixed service link, provisioned by beams that continuously cover the same geographic areas all the time, such as a GSO satellite. In some examples, the second type of service link is a quasi-earth-fixed service link, provisioned by beams that cover one geographic area for a limited period and another geographic area at a different time, such as an NGSO satellite generating steerable beams. In some examples, the third type of service link is an earth-moving service link, provisioned by beams whose coverage area slides over the earth's surface, such as NGSO satellite generating fixed or non-steerable beams.

In at least one example, a base station (BS), operating with the NGSO satellite, can provide either quasi-earth-fixed cell coverage or earth-moving cell coverage. In another example, a BS operating with the GSO satellite, can provide earth-fixed cell coverage. Due to different properties of GSO and NGSO, different types of cells can be supported in the NTN including, for example, an earth-fixed cell, a quasi-earth-fixed cell, and an earth-moving cell. For a certain type of NTN payload or cell, the UE needs to support specific features or functionalities for radio access to the NTN.

In some examples, in an NTN, a satellite can provide a limited number of active satellite beams for a certain geographic area during a given time period due to limited power. In some examples, there can be areas of an NTN cell that are out of service because of a lack of active beam serving. In some examples, a serving cell and a neighboring cell may not be serviced at a same time—e.g., the satellite can provide active beams to the serving cell at a first time but active beams to the neighboring cell at a second time, different than the first time. Additionally, the limited number of active satellite beams can correspond to different types of signaling. For example, some active satellite beams can serve common signaling (e.g., system information). In other examples, active satellite beams can serve active data user (e.g., transmit data over a physical downlink shared channel (PDSCH), etc.). In at least one example, the satellite in the NTN system can adjust a pattern of active and inactive beams to accommodate traffic demands. In such systems however, a UE is not always provided active service of the user data—e.g., the UE may be out of the service area. Further, as conventional solutions do not provide the UE with the active beam pattern information, the UE may monitor active and inactive beams as well as measure inactive neighboring cells. In some examples, the UE can consume additional power resources in trying to monitor the active beams. That is, present solutions may have the network handle all of the active beam pattern information, forcing the UE to monitor the beams and using additional power as a result.

The present disclosure provides a mechanism related to UE receiving and using active beam pattern information—e.g., provides a mechanism for the UE to directly use the active beam pattern information. For example, the present disclosure provides details on signaling and UE behavior when active beam patterns are specified. In at least one example, an active beam pattern can also be referred to as beam-based discontinuous transmission (DTX) or discontinuous reception (DRX) information. That is, the active beam pattern can refer to a beam DTX/DRX or a cell DTX/DRX (e.g., “active beam pattern” is used interchangeably with “beam DTX/DRX,” “cell DTX/DRX,” “DTX/DRX information,” “DTX/DRX pattern,” and “DTX/DRX configuration.”). It should be noted that although aspects of the present disclosure are discussed in the context of NTN, the present disclosure is applicable for any wireless network (e.g., for terrestrial based 5G networks)

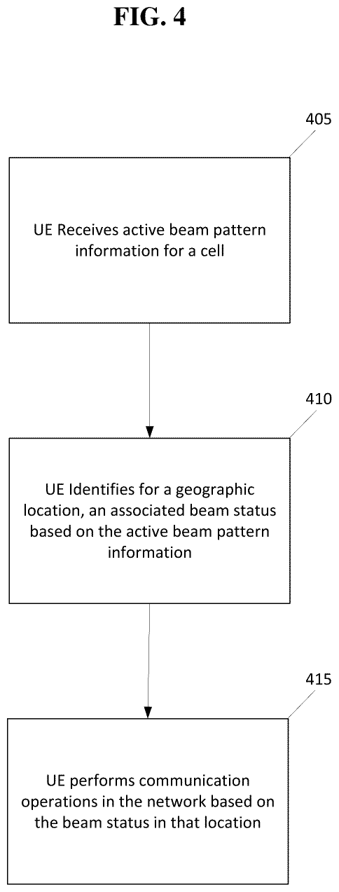

FIG. 4 shows an example process 400 for receiving and using active beam pattern information in accordance with an embodiment. For explanatory and illustration purposes, the example process 400 may be performed by an UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods.

Referring to FIG. 4, the process 400 may begin at operation 405. In operation 405, the UE receives active beam pattern information for a cell. In one embodiment, the UE receives beam pattern information for an NTN cell. In at least one embodiment, the UE can receive the active beam pattern information from a base station (e.g., gNB or base station 101, base station 102, and/or base station 103 as described with reference to FIG. 1). In at least one embodiment, the beam pattern information can be transmitted as part of system information. For example, in NR NTN systems, the active beam pattern information can be transmitted in system information block (SIB) 19 (e.g., a specific parameter for serving cell and or neighbor cells containing satellite assistance information). In other examples, the beam pattern information can be transmitted in UE dedicated signaling. For example, the active beam pattern information can be transmitted as part of a Radio Resource Control (RRC) Reconfiguration message. In at least one embodiment, the active beam pattern information can include a list of beams, each identified by a beam ID. In some embodiments, each beam within the list includes information regarding a geographic illumination area (e.g., an area actively serviced by beams or an applicable geographic area for a DTX/DRX pattern) and/or active times. In some embodiments, a beam can be an NR beam with an NR beam ID (e.g., Synchronization Signal Block (SSB) index). In other embodiments, a beam can be a satellite beam identified by a satellite beam ID.

In at least one embodiment, a geographic illumination area for a beam can be identified by beam parameters. For example, the geographic illumination area can be represented by a bore sight direction and/or a half-power beamwidth (e.g., a “3 dB beamwidth” or an angle at which an antenna's radiation pattern decreases by fifty percent (50%).) In at least one embodiment, the boresight direction is indicated by an azimuth angle and/or a zenith angle. In some embodiments, the 3 dB width is indicated by an angle parameter. In embodiments where the geographic illumination area is identified by beam parameters, the UE can determine the beam diameter and the beam spacing based on receiving the bore sight direction and/or the 3 dB beam width.

In another embodiment, the geographic illumination area for a beam can be identified by a leftmost elevation angle, a rightmost elevation angle, a radius, and/or reference coordinates. In at least one embodiment, the angle parameters (e.g., the leftmost elevation angle, the rightmost elevation angle, the azimuth angle, the zenith angle) can be defined by an integer value x in a range from −X to X (e.g., the UE can receive signaling corresponding to the inter value defining the angle). In at least one embodiment, a step size for the angle parameters can be pre-defined. For example, an actual angle value is indicated by x*pre-defined step size. In other embodiments, an angle parameter can be indicated by an integer ranging from 0° to 359° or from 1° to 360° (e.g., the angle parameter can indicate an angle within a full circle from 0° to 360°). In at least one embodiment, if a leftmost elevation angle is absent, the leftmost elevation can be assumed to be equal to a value of a rightmost elevation angle. In some embodiments, a radius indicates a distance between the reference point and an edge of a satellite or beam coverage. In at least one embodiment, the radius has a unit kilometer (km). In other embodiments, the radius has a different unit (e.g., in meters (m), miles, feet, centimeters, etc.). In at least one embodiment, the radius can be represented as a pre-defined step size multiplied by an integer value—e.g., the actual radius is determined by multiplying the integer value received with the pre-defined step size. In some embodiments, a reference coordinate can be represented by a longitude and latitude coordinate. In such examples, each coordinate can be represented by a pre-defined step size multiplied by an integer value—e.g., the actual reference coordinates are determined by multiplying a positive or negative integer value received with the pre-defined step size.

In still other embodiments, the geographic illumination area can be represented by center coordinates and a radius. In some embodiments, the center coordinates are signaled as a bit string (e.g., in a bit string having a format of Ellipsoid-Point as defined in TS37.355). In such embodiments, a first/leftmost bit of a first octet includes a most significant bit. In at least one embodiment, the radius can represent a distance from the center coordinates. In one embodiment, the radius is signaled as an integer value with a unit of meters. In other embodiments, the radius is an integer value with unit of kilometers (km), miles, feet, yards, centimeters, etc.

In other embodiments, the geographic illumination area is represented by a polygon as defined in TS23.032. For example, the polygon can be an arbitrary shape described by a series of points, where the polygon has at least three (3) minimum number of points and no more than a maximum fifteen (15) number of points. In some embodiments, the points are connected in an order they are given, where a connecting line refers to a line over an ellipsoid joining two points of minimum distance (e.g., geodesic). In such embodiments, the last point is connected to the first point. In one example, a list of points follows the following conditions:
1. A connecting line shall not cross another connecting line
2. Two successive points must not be diametrically opposed on an ellipsoid

In some examples, the polygon is situated to a right of the lines with a downward direction being toward the Earth's center and the forward direction being from a point to the next point. In some examples, the polygon information can be signaled in a format of Polygon as defined in TS37.355.

In at least one embodiment, an active time of a beam or a DTX/DRX pattern indicates a start time, an end time, an on-duration, a start offset, a periodicity, and/or an active status. In one example, the start time and/or end time can be represented by a symbol number, a subframe number, and/or a system frame number (SFN) with respect to a reference time. In other embodiments, the start time and/or end time can be represented by an absolute time with respective to a reference time. In some embodiments, the reference time can be an uplink time synchronization reference point of a current serving cell. In other embodiments, the reference time can be the absolute time. For example, the reference time can be an absolute time indicated in multiples of ten (10) microseconds (ms) after 00:00:00 on Gregorian calendar date 1 Jan. 1900 (midnight between Sunday, Dec. 31, 1899 and Monday, Jan. 1, 1900). In some embodiments, an exact stop time is between a time indicated by a value of the start time minus one and the time indicated by a value of the end time. That is, in some embodiments, the UE can have a higher granularity of time than a received or indicated time. For example, a UE can have a higher granularity of time than an indicated time 12:12:12. In such examples, the UE can determine the exact time is between 12:12:11 (e.g., the time minus one) and 12:12:12. In some embodiments, a start offset indicates an offset to a start time from which point a beam is active for the indicated on-duration or active until the end time. In other embodiments, the start offset can indicate an offset to the start time of the active state duration, the inactive state duration, or the off-state duration. In one embodiment, an active status indicates whether the beam is active to serve common signaling or to serve user data. In other embodiments, the active status indicates whether the BS is an active or inactive state. In at least one embodiment, a periodicity can indicate how long until a start time occurs again.

In other embodiments, the active time (e.g., an active state duration time) of a beam or a DTX/DRX pattern indicates a start time, two on-durations, a start offset, and/or a periodicity. In at least one example, a first on-duration indicates a duration for a beam to service active data traffic and a second on-duration indicates a duration for a beam to service common signaling. In such embodiments, a start offset indicates an offset between the start time of the beam active during the first duration and the start time of the beam active during the second duration (e.g., a time between the beam starting active data transmission and the beam starting common signaling). In other examples, the first on-duration indicates the duration for the active state and the second on-duration indicates the duration for the inactive state. In such embodiments, the start offset indicates an offset between a start time of the active state duration and a start time of the inactive state duration (e.g., or off state duration). In at least one embodiment, a periodicity can indicate how long until a start time occurs again. In one example, a start time can be represented by a symbol number, a subframe number, and/or a system frame number (SFN) with respect to a reference time. In other embodiments, the start time can be represented by an absolute time with respective to a reference time. In some embodiments, the reference time can be an uplink time synchronization reference point of a current serving cell. In other embodiments, the reference time can be the absolute time. For example, the reference time can be an absolute time indicated in multiples of ten (10) microseconds (ms) after 00:00:00 on Gregorian calendar date 1 Jan. 1900 (midnight between Sunday, Dec. 31, 1899 and Monday, Jan. 1, 1900). In some embodiments, an exact stop time is between a time indicated by a value of the start time minus one and the time indicated by a value of this field as described above—e.g., the UE can have a higher granularity of time than the indicated time.

In other embodiments, the active time (e.g., an active state duration time) of a beam or a DTX/DRX pattern indicates parameters used for cell DTX/DRX (e.g., the parameters for cell DTX/DRX are reused). For example, the active time can include an on time duration (e.g., onDurationTimer), a time when a cycle starts (e.g., CycleStartOffset), a slot offset (e.g., SlotOffset), and/or an activation status (e.g., activationStatus). In at least one embodiment, the activation status indicates whether a beam is active to serve common signaling or the beam is active to serve actual traffic data. In other embodiments, the activation status indicates whether a particular DTX/DRX pattern is activated, based on receiving the active beam pattern information.

In some embodiments, multiple beam patterns can be configured and stored. For example, the UE can configure one or multiple beam-level DTX/DRX patterns. In such embodiments, each DTX/DRX pattern is identified by a logical ID, configured with active time, configured with inactive time, configured with on time, configured with off time, and/or associated to a geographic area. In one example, the UE can add to or modify the list of beam-level DTX/DRX patterns. In some embodiments, the UE can release DTX/DRX patterns by indicating the ID the of beam-level DTX/DRX patterns. In one example, each DTX/DRX pattern or configuration, one or multiple of the following parameters can be configured:
DTXDRXconfigType is a parameter that indicates whether a beam pattern is for DTX, DRX, or both.
Dtxdrx-onDurationTimer is a parameter that indicates an active duration at a beginning of a DTX/DRX cycle.
Dtxdrx-StartOffset is a parameter that defines a subframe where the DTX/DRX cycle starts.
Dtxdrx-SlotOffset is a parameter that indicates a delay before starting the Dtxdrx-onDurationTimer
Dtxdrx-Cycle is a parameter indicating the DTX/DRX cycle period
DTXDRXactivationStatus is a parameter that indicates an initial activation status of the DTX/DRX operation

In operation 410, the UE identifies for a geographic location of the cell, an associated beam status based on receiving the active beam pattern information. That is, based on the active beam pattern information, the UE can determine for a certain geographic area whether an active beam for common signaling or an active beam for user data is available to serve the geographic location. In some embodiments, UE can determine there are no active beams to serve a certain geographic area. In such embodiments, the UE can predict an out of coverage duration for the geographic area (e.g., for the geographic area the UE is located in). In at least one embodiment, the UE can stop monitoring a physical downlink control channel (PDCCH) for a serving cell when the UE determines there are no active beams—e.g., the UE can stop paging.

In operation 415, the UE performs a communication operation in the network based on the UE identifying the associated beam status for a geographic area. In some embodiments, the communication operation can refer to the UE transitioning into or out of a power state, hand over operations (e.g., conditional handover (CHO)), cell reselection operations, etc. For example, the UE can determine there are active beams in a geographic area being transmitted for common signaling during a duration. In such embodiments, the UE can predict a duration that geographic area will continue being served with the common signaling beams and perform an operation. For example, the UE can predict a first duration in a first geographic area in a serving cell in which the first geographic area does not have an active downlink (DL) or uplink (UL) data transmission. In such embodiments, the UE can stay in an idle state (e.g., RRC idle/inactive state) and perform an idle/inactive operation (e.g., RRC_IDLE/INACTIVE) operation if the UE is in the first geographic area during the first duration—e.g., the UE can monitor PDCCH for paging, single-sideband modulations (SSBs), perform random access channel (RACH) operations, etc. during the first duration in the first geographic area. In some embodiments, the UE can further refrain from monitoring the PDCCH for DL assignments, for UL scheduling, refrain from monitoring semi-persistent scheduling (SPS) occasions, refrain from transmitting on configured grant (CG) resources, refrain from transmitting a scheduling request (SR), refrain from transmitting periodic and semi-persistent channel state information (CSI) reports, and/or refrain from transmitting periodic and semi-persistent sounding reference signal (SRS) during the first duration. In some embodiments, the UE can acquire (e.g., reacquire) system information and/or monitor PDDCH for paging (e.g., and/or short messages) when there are active beams—e.g., by utilizing the active beam pattern information, the UE can have better power management and stay in idle modes unless there is an active beam. For example, the UE can perform RACH (e.g., by sending PRACH preamble after selecting from active SSBs) when there are active beams and refrain from RACH when there are no active beams.

In some embodiments, the UE can determine there is an active beam(s) for a certain area for a certain duration. In such embodiments, the UE can predict a duration for which it can transmit and receive user data. That is, the UE can determine a duration in which the UE is in an RRC connected state and perform a connected state operation (e.g., an RRC_CONNECTED operation) during the duration. By using the active beam pattern information, the UE can perform the RRC_CONNECTED operation when there are active beams only (e.g., an SSB selection). For example, the UE can select an SSB beam based on the active beam pattern information and perform measurements on the serving cell and/or neighbor cells based on the selected SSB beam—e.g., by using a configuration (e.g., SSB measurement timing configuration (SMTC)).

In some embodiments, the UE can use the DTX/DRX pattern to identify the associated beam status for a geographic area and perform an operation. For example, the UE can determine an off state, an active state, and/or an inactive state for a geographic area based on the DTX/DRX patterns received. In at least one embodiment, the UE can determine it is out of coverage (e.g., outside the beam service area) if the UE determines the off state. In such embodiments, the UE can refrain from monitoring PDCCH of the serving cell. In some embodiments, the UE can further declare radio link failure (RLF) and perform a cell reselection. In other embodiments, the UE can determine the inactive state based on the DTX/DRX patterns. In such embodiments, the UE can refrain from monitoring PDCCH for DL assignment and for UL scheduling, refrain from monitoring SPS occasions, refrain from transmitting on CG resources, refrain from transmitting a SR, refrain from transmitting periodic and semi-persistent CSI reporting, refrain from transmitting periodic and semi-persistent SRS. In such embodiments, the UE can further acquire (e.g., reacquire) system information, monitor PDCCH for paging (e.g., for short message), perform RACH, and or monitor PDCCH for retransmissions.

In at least one embodiment, a network (e.g., NW) can activate or deactivate a DTX/DRX pattern from a configured list of DTX/DRX patterns. In one example, the NW can activate or deactivate the DTX/DRX pattern by indicating a corresponding logical identification (ID) via UE signaling (e.g., RRC), via medium access control (MAC) control elements (CE) (e.g., via MAC CE), or via the downlink control information (DCI). In at least one embodiment, the UE can activate or deactivate the DTX/DRX pattern based on an RRC parameter. For example, the UE can utilize an RRC parameter to indicate whether a serving cell has enabled lower layer (e.g., Layer one (L1) or layer two (L2)) signaling for dynamic activation and deactivation of the DTX/DRX patterns. In one embodiment, the UE can receive the indication as part of a MAC CE. In such embodiments, the UE can receive a logical channel identification (LCID) or extended logical channel identification (eLCID) as part of the MAC CE indicating the activation or deactivation of the DTX/DRX pattern. In another embodiment, the UE can receive the indication in a DCI format (e.g., DCI format 2_9). In some embodiments, the MAC CE or the DCI format can include a field indicating a serving cell ID to identify the serving cell the MAC CE or DCI is applied to. In at least one embodiment, the MAC CE or DCI format can include a field that indicates DTX/DRX pattern IDs to indicate which DTX/DRX patterns to activate or deactivate. In some embodiments, the MAC CE or DCI format includes a one-bit field to indicate the DTX/DRX pattern ID. In some embodiments, the UE can activate or deactivate a pattern based on receiving a respective DCI or MAC CE including the DTX/DRX pattern ID.

In one embodiment, the UE can receive an activating or deactivation indication (e.g., via the logical ID indicated). In such embodiments, the UE can refrain from applying a DTX/DRX pattern if the logical ID indicates the pattern is deactivated. In other embodiments, the UE can apply an indicated pattern received via the logical ID. In at least one embodiment, a DTX/DRX pattern can be in a release list. In such embodiments, the UE can deactivate and release the DTX/DRX pattern based on receiving the release list in an RRC message. In at least one embodiment, for activated DTX/DRX patterns, the UE can consider itself out of coverage if in an off state. In such embodiments, the UE can stop monitoring the PDCCH of the serving cell. In some embodiments, the UE can further declare a radio link failure (RLF) and proceed to performing a cell reselection. As described above, when in an inactive state, the UE can refrain from monitoring PDCCH for DL assignment and for UL scheduling, refrain from monitoring SPS occasions, refrain from transmitting on CG resources, refrain from transmitting a SR, refrain from transmitting periodic and semi-persistent CSI reporting, refrain from transmitting periodic and semi-persistent SRS. In some embodiments, the UE can further acquire (e.g., reacquire) system information, monitor PDCCH for paging (e.g., for short message), perform RACH, and or monitor PDCCH for retransmissions while the UE is in the inactive state.

In at least one embodiment, a DTX operation for a DTX pattern/configuration among a list of DTX patterns (e.g., a process to activate or deactivate a DTX pattern) for each serving cell is performed by receiving an indication from lower layers and configuring upper layers. For example, the serving cell can activate or deactivate DTX patterns by:
Receiving a DTX indication from lower layers (e.g., L1 via DCI) indicating activation or deactivation of a DTX pattern/configuration;
Configuring by upper layers: if DTX type is configured and DTXDRXactivationStatus is set to activated for a DTX pattern, a DTX operation is activated for the DTX configuration; if DTX type is configured and DTXDRXactivationStatus is set to deactivated, DTX operation is deactivated for the DTX configuration; if a DTX pattern/configuration is released, a DTX operation for the DTX configuration is deactivated and all the corresponding configurations are released.

In at least one embodiment, a DRX operation for a DRX pattern/configuration among a list of DRX patterns (e.g., a process to activate or deactivate a DRX pattern) for each serving cell is performed by receiving an indication from lower layers and configuring upper layers. For example, the serving cell can activate or deactivate DRX patterns by:
Receiving a DRX indication from lower layers (e.g., L1 via DCI) indicating activation or deactivation of a DRX pattern/configuration;
Configuring by upper layers: if DRX type is configured and DTXDRXactivationStatus is set to activated for a DRX pattern, a DRX operation is activated for the DRX configuration; if DRX type is configured and DTXDRXactivationStatus is set to deactivated, DRX operation is deactivated for the DRX configuration; if a DRX pattern/configuration is released, a DRX operation for the DRX configuration is deactivated and all the corresponding configurations are released.

In at least one embodiment, the UE can receive a new DTX/DRX pattern. For example, the UE can receive a new DTX/DRX pattern during a DRX/DTX operation. In such embodiments, the UE can deactivate the currently activated DTX/DRX patterns and activate the new received DTX/DRX pattern.

In at least some embodiments, a network (NW) can handover a UE in an area where beams switch from active traffic status to common signaling status (e.g., or an area that is going to switch to an inactive or off state) to a cell with active beams or with an active state before the switch occurs—e.g., the NW can release the UE in the area to an idle or inactive state (e.g., RCC_IDLE or RCC_INACTVIE). In some embodiments, the NW can release the UE in an area to an idle state (e.g., RCC_IDLE) if beams switch from active traffic status to an off status for the area—e.g., the NW can release the UE before the switch occurs. In some embodiments, the NW can release the UE access stratum (AS) context. In other embodiments, the NW can release the inactive state (e.g., RCC_INACTIVE) UE in an area to an idle state (e.g., RCC_IDLE) before the area beams switch from common signaling status to off status. In other embodiments, the NW can release the UE AS context before the switch in the area.

In at least one embodiment, one or multiple beams or DTX/DRX patterns can be associated to each intra-frequency and/or each inter-frequency (e.g., as indicated by ARFCN value) in a frequency list and/or associated to each neighbor cell PCI/frequency in the neighbor cell list. In at least one embodiment, the UE is aware of an active beam pattern, inter-frequency, and/or an intra-frequency for a neighboring cell based on receiving the active beam pattern information. For example, the UE can apply measurement rules for cell reselection on neighbor cells, apply inter-frequencies, and/or intra-frequencies when active beams for common signaling and or user data are available for the neighbor cell, inter-frequency with higher/lower priorities, and/or intra-frequency.

In at least one embodiment, the UE can prioritize a neighbor cell, an inter-frequency, and/or an intra-frequency if active beams for either common signaling or user data (e.g., or active beams both common signaling and user data) are available for a respective neighbor cell, an inter-frequency, and/or an intra-frequency. In at least one embodiment, the UE can also prioritize a neighbor cell, an inter-frequency, and/or an intra-frequency during an active time of the neighbor cell—e.g., during a time the neighboring cell is serviced by active beams. In at least one embodiment, the UE can refrain from considering a neighboring cell, the inter-frequency, and/or the intra-frequency for cell reselection or for measurement during an off-time or during an inactive time—e.g., at a time where there are no active beams. In other embodiments, the UE can first prioritize a first frequency or first neighboring cell associated with active data traffic beams available and then second prioritize a second frequency or second neighboring cell associated with common signaling—e.g., the UE can prioritize the frequency or neighboring cell with active data being transmitted over the frequency or neighboring cell with common signaling being transmitted. In other embodiments, the UE can prioritize the frequency where any active beams are available. In such embodiments, UE configurations (e.g., UE implementation) and settings can determine a type of active beam to prioritize. In at least some embodiments, the UE can first prioritize a frequency or neighbor cell that is active and then second prioritize a frequency or neighboring cell that is inactive—e.g., the UE can deprioritize the frequency and the neighboring cell that is inactive. In at least one embodiment a frequency or neighboring cell can be active if during a respective duration there are active beam patterns—e.g., user data or common signaling data is being transmitted.

In some embodiments, the active beam pattern information can also be included as part of a conditional handover (CHO) operation. That is, the CHO configuration includes active beam pattern information for each CHO candidate cell, such that the UE can evaluate CHO execution conditions and select a target cell for CHO based on the active beam pattern information. In at least one embodiment, when the CHO configuration for a candidate cell includes the active beam pattern information, the UE can evaluate the CHO execution condition for the candidate cell with the active beam pattern information. In such embodiments, the UE can evaluate the CHO execution condition when any active beam for common signaling or user data is available for the candidate cell. In at least one embodiment, the UE can select an applicable cell as a target cell for CHO execution based on determining an active beam for user data is available in the candidate cell.

In at least one embodiment, the UE transmits an indication to a network (NW) indicating whether the UE supports access to a non-terrestrial network (NTN) cell with an active beam pattern. In at least one embodiment, the indication of the UE's capabilities is represented by a cell barring bit included in system information block one (SIB1). For example, the cell barring bit (e.g., cellBarredActiveBeamPattern) can indicate whether the cell broadcasting the SIB1 is barring the UE not capable of NTN access with active beam pattern or that the UE is capable to support NTN access with the active beam pattern. In at least one embodiment, UEs capable of NTN active beam pattern can receive the cell barring bit—e.g., the cell barring bit is only applicable to UEs capable of NTN access in some embodiments. In at least one embodiment, if there are multiple public land mobile networks (PLMNs) and/or non-public networks (NPNs) indicated in the SIB1, the cell barring bit is common for all of the PLMNs and NPNs indicated. In at least one embodiment, if a UE capable of accessing an NTN active beam pattern does not receive the cell barring bit (e.g., the cell barring bit is absent in SIB1) or if the UE receives the cell barring bit indicating “barred” in SIB1, the UE can consider the cell barred—e.g., the cell transmitting the cell barring bit indicating “barred” or the cell transmitting the SIB1 without the cell barring bit can be considered “barred” from the perspective of the UE. Accordingly, a UE capable of NTN access can acquire SIB1 to determine whether a cell is an NTN cell before performing additional operations. In at least one embodiment, the UE can receive the SIB1 and determine if the cell is an NTN by following a first procedure (Procedure 1) as follows:

Upon receiving the SIB1, the UE shall:
1> store the acquired SIB1:
1> if the access is for NTN:
   2> if the UE is in an idle state (e.g., RCC_IDLE) or in an inactive state (e.g., RCC_INACTIVE), or if the UE is in a connected state (e.g., RCC_CONNECTED) while a timer (e.g. T311) is running:
      3> if the cellBarredNTN in the acquired SIB1 is set to barred or the cellBarredNTN is not included in the acquired SIB1:
         4>consider the cell as barred in accordance with TS 38.304 [20];
         4> perform cell re-selection to other cells on the same frequency as the barred cell as specified in TS38.304 [20], upon which the procedure ends;
      3> if the UE is capable of active beam pattern and the cellBarredActiveBeamPattern in the acquired SIB1 is set to barred or the cellBarredActiveBeamPattern is not included in the acquired SIB1, or
         4>consider the cell as barred in accordance with TS38.304 [20];
         4> perform cell re-selection to other cells on the same frequency as the barred cell as specified in TS38.304 [20], upon which the procedure ends.

In other embodiments, the UE can receive the SIB1 and determine if the cell is an NTN by following a second procedure (Procedure 2) as follows:

Upon receiving the SIB1, the UE shall:
1> store the acquired SIB1:
1> if the access is for NTN:
   2> if the UE is in an idle state (e.g., RCC_IDLE) or in an inactive state (e.g., RCC_INACTIVE), or if the UE is in a connected state (e.g., RCC_CONNECTED) while a timer (e.g. T311) is running:
      3> if the cellBarredNTN in the acquired SIB1 is set to barred or the cellBarredNTN is not included in the acquired SIB1:
         4> if the UE is capable of active beam pattern:
         5>cellBarredActiveBeamPattern in the acquired SIB1 is set to barred or the cellBarredActiveBeamPattern is not included in the acquired SIB1:
         6>consider the cell barred in accordance with TS38.304 [20]
         6> perform cell re-selection to other cells on the same frequency as the barred cell as specified in TS38.304 [20], upon which the procedure ends.
         4> else:
         5>consider the cell as barred in accordance with TS38.304 [20];
         5> perform cell re-selection to other cells on the same frequency as the barred cell as specified in TS38.304 [20], upon which the procedure ends.
      3> if the UE is a fixed very small aperture terminal (VSAT) UE and the cellBarredFixedVSAT in the acquired SIB1 is set to barred or the cellBarredFixedVSAT is not included in the SIB1, or
      3> if the UE is a mobile VSAT UE and the cellBarredMobileVSAT in the acquired SIB1 is set to barred or the cellBarredMobileVSAT is not included in the acquired SIB1:
         4>consider the cell as barred in accordance with TS38.304 [20]
         4> perform cell re-selection to other cells on the same frequency as the barred cell as specified in TS38.304 [20], upon which the procedure ends.

That is, as described in procedure two, there can be additional bits indicating the “barred” status based on the UE capabilities. For example, the SIB1 can include a cell barring bit for fixed or mobile very small aperture terminal (VSAT) UEs as described above.

In at least some embodiments, “active beam pattern” operations can correspond to (default) synchronization signal block (SSB) periodicity extension up to 160 microseconds (ms) and/or 320 microseconds (ms). In other embodiments, “active beam pattern” operations can correspond to downlink (DL) coverage enhancement for NTN access. Accordingly, “active beam pattern” terminology can be replaced (e.g., is the same as) by SSB extensions or DL coverage enhancement. In other embodiments, additional terminologies capturing the operations of “active beam pattern” can be used.

In one embodiment, a network (NW) can use a bit in system information block one (SIB1) for a cell barring indication to prohibit UEs, capable of accessing an active beam pattern, to access an NTN cell. In one embodiment, the bit can have a field name cellBarredNTN-DLcoverage. That is, the system can use “DLcoverage” terminology in lieu of “active beam pattern.” In one embodiment, a value (e.g., a value corresponding to) “barred” means that a cell is barred for connectivity for an NTN with DL coverage enhancement. In such embodiments, a value (e.g., a value corresponding to) “notBarred” means that a cell is allowed for connectivity to an NTN with DL coverage enhancement. In at least one embodiment, if the bit is not present in SIB1 (e.g., there is no bit in the cellBarredNTNDLcoverage field of SIB1), the UE considers the cell as barred for connectivity to the NTN with DL coverage enhancement. In at least one embodiment, the bit is applicable to NTN capable UEs and/or UEs supporting NTN DL coverage enhancement—e.g., the bit is not applicable to non-NTN capable UEs and UEs that do not support NTN DL coverage. In at least one embodiment, if there are multiple PLMNs indicated in SIB1, the field is common for all of the PLMNs indicated in SIB1. In at least one embodiment, a UE that does not support NTN access with DL coverage enhancement can ignore the field.

In at least one embodiment, the UE can receive the SIB1 and determine if the cell is barred or not barred based on the indicated bit (e.g., cellBarredNTNDLcoverage) based on the following procedure (Procedure 3) as follows:

Upon receiving the SIB1, the UE shall:
1> store the acquired SIB1:
1> if the access is for NTN:
   2> if the UE is in an idle state (e.g., RCC_IDLE) or in an inactive state (e.g., RCC_INACTIVE), or if the UE is in a connected state (e.g., RCC_CONNECTED) while a timer (e.g. T311) is running:
      3> if the UE is capable of active beam pattern and the cellBarredNTN-DLcoverage in the acquired SIB1 is set to barred or the cellBarredNTN-DLcoverage is not included in the acquired SIB1, or
         4>consider the cell as barred in accordance with TS 38.304 [20];
         4> perform cell re-selection to other cells on the same frequency as the barred cell as specified in TS38.304 [20], upon which the procedure ends;
      3> else if the cellBarredNTN in the acquired SIB1 is set to barred or the cellBarredNTN is not included in the acquired SIB1:
         4>consider the cell as barred in accordance with TS38.304 [20];
         4> perform cell re-selection to other cells on the same frequency as the barred cell as specified in TS38.304 [20], upon which the procedure ends.

In other embodiments, the UE can receive the SIB1 and determine if the cell is barred by following a fourth procedure (Procedure 4) as follows:

Upon receiving the SIB1, the UE shall:
1> store the acquired SIB1:
1> if the access is for NTN:
   2> if the UE is in an idle state (e.g., RCC_IDLE) or in an inactive state (e.g., RCC_INACTIVE), or if the UE is in a connected state (e.g., RCC_CONNECTED) while a timer (e.g. T311) is running:
      3> if the UE supports DL coverage enhancement features (e.g., active beam pattern, and/or cell/beam DTX/DRX, and/or SSB periodicity extension, etc.):
         4> if the cellBarredNTN-DLcoverage in the acquired SIB1 is set to barred or the cellBarredNTN-DLcoverage is not included in the acquired SIB1, or
         5>consider the cell barred in accordance with TS38.304 [20];
         5> perform cell re-selection to other cells on the same frequency as the barred cell as specified in TS38.304 [20], upon which the procedure ends.
         4> if the UE is a fixed very small aperture terminal (VSAT) UE and the cellBarredFixedVSAT in the acquired SIB1 is set to barred or the cellBarredFixedVSAT is not included in the SIB1, or
         4> if the UE is a mobile VSAT UE and the cellBarredMobileVSAT in the acquired SIB1 is set to barred or the cellBarredMobileVSAT is not included in the acquired SIB1:
         5>consider the cell as barred in accordance with TS38.304 [20]
         5> perform cell re-selection to other cells on the same frequency as the barred cell as specified in TS38.304 [20], upon which the procedure ends;
      3> else
         4> if the cellBarredNTN in the acquired SIB1 is set to barred or the cellBarredNTN is not included in the acquired SIB1:
         5>consider the cell as barred in accordance with TS38.304 [20];
         5> perform cell re-selection to other cells on the same frequency as the barred cell as specified in TS38.304 [20], upon which the procedure ends
         4> if the UE is a fixed VSAT UE and the cellBarredFixedVSAT in the acquired SIB1 is set to barred or the cellBarredFixedVSAT is not included in the SIB1, or
         4> if the UE is a mobile VSAT UE and the cellBarredMobileVSAT in the acquired SIB1 is set to barred or the cellBarredMobileVSAT is not included in the acquired SIB1:
         5>consider the cell as barred in accordance with TS38.304 [20]
         5> perform cell re-selection to other cells on the same frequency as the barred cell as specified in TS38.304 [20], upon which the procedure.

In at least one embodiment, for the base address register (bar) bit cellBarredFixedVSAT, a value “barred” indicates a cell is barred for fixed VSAT UEs, as defined in TS 38.304 [20]. In at least one embodiment, if the bar bit cellBarredFixedVSAT is not present, it indicates a cell is not allowed for fixed VSAT UEs. In at least one embodiment, non-VSAT UEs can ignore the bit cellBarredFixedVSAT. In at least one embodiment, for the bar bit cellBarredMobileVSAT, a value “barred” indicates a cell is barred for mobile VSAT UEs, as defined in TS 38.304 [20]. In at least one embodiment, if the bar bit cellBarredMobileVSAT is not present, it indicates a cell is not allowed for mobile VSAT UEs. In at least one embodiment, non-VSAT UEs can ignore the bit cellBarredMobileVSAT. In at least one embodiment, the cellBarredFixedVSAT and cellBarredMobileVSAT are optional bits. In one embodiment, the cellBarredFixedVSAT and cellBarredMobileVSAT bits are present in a cell where cellBarredNTN or CellBarredNTN-DLcoverage is included with a value “notBarred” and are absent otherwise.

In one embodiment, a cell barring indication is indicated using a bit in master information block (MIB). In such embodiments, the cell barring bit can have a filed name cellBarredNTN-DLcoverage. In one embodiment, a value “barred” for the cell barring bit indicates the cell is barred from connectivity to an NTN with DL coverage enhancement. In at least one embodiment, a value “notBarred” for the cell barring bit indicates the cell is allowed connectivity to the NTN with DL coverage enhancement. In at least one embodiment, if the cellBarredNTN-DLcoverage bit is not present, a UE can consider the cell is not allowed connectivity to the NTN with DL coverage enhancement. In at least one embodiment, the cellBarredNTN-DLcoverage bit is applicable to NTN-capable UEs. In at least one embodiment, a UE capable of NTN access but incapable of SSB extension can acquire SIB1 to determine if the cell is an NTN cell as described above. In some embodiments, if there are multiple PLMNs indicated in SIB1, the cellBarredNTN-DLcoverage field is common to all of the PLMNs indicated in SIB1. In at least one embodiment, a UE that does not support the NTN access with DL coverage enhancement can ignore the field. In some embodiments, the field is applicable for UEs supporting NTN access with DL coverage enhancement.

In at least one embodiment, the UE can receive the MIB1 and determine if a cell is barred for access following a fifth procedure (Procedure 5) as follows:

Upon receiving the MIB, the UE shall:
1> store the acquired MIB:
1> if the UE is in an idle state (e.g., RCC_IDLE) or in an inactive state (e.g., RCC_INACTIVE), or if the UE is in a connected state (e.g., RCC_CONNECTED) while a timer (e.g. T311) is running:
   2> if the access is not for NTN or the UE is not capable of NTN; and
   2> if the UE does not support nes-CellDTX-DRX (e.g., UE is not capable of configuring UE to use DRX); and
   2> if the access is not for air-to-ground (ATG) or the UE is not capable of ATG; and
   2> if the cellBarred in the acquired MIB is set to barred;
      3> if the UE is a reduced capability (RedCap) or enhanced reduced capability (eRedcap) or if UE is a two antenna port extended reality (2Rx XR) UE and if ssb-SubcarrierOffset indicates SIB1 is transmitted in the cell as defined in TS 38.213 [13];
         4>acquire the SIB1, which is scheduled as specified in TS 38.213 [13];
      3>consider the cell as barred in accordance with TS 38.304 [20];
      3> perform cell re-selection to other cells on the same frequency as the barred cell as specified in TS 38.304 [20];
   2> else if the access is for NTN and UE is capable of SSB extension; and
   2> if the cellBarredNTNSSBextended is not set to barred;
      3>consider the cell as barred in accordance with TS 38.304 [20];
      3> perform the cell-reselection to other cells on the same frequency as the barred cell as specified in TS 38.304 [20];
   2> else:
      3> apply the received system Frame Number, pdcch-ConfigSIB1, subCarrierSpacingCommon, ssb-SubcarrierOffset and dmrs-TypeA-Position.

In some embodiments, one bit in the MIB can be used to indicate whether the SSB Periodicity is 160 microseconds (ms) or 20 ms. In one embodiment, the one bit in the MIB can indicate a first value (e.g., zero (0)) associated with an SSB periodicity of 160 ms or indicate a second value (e.g., one (1)) associated with an SSB periodicity of a spare value.

In at least one embodiment, a network (NW) can provide SSB periodicity extension information for neighboring cells during a cell reselection operation. In one embodiment, the UE can use the SSB periodicity information of neighboring cell to perform measurements as part of the cell reselection operation. For example, a SSB-based radio resource management (RRM) measurement timing configuration (e.g., STMC) can have a value 320 ms as a periodicity and an offset of a start of the SMTC window can have a value between 0 and 319 subframes. In at least one embodiment, the periodicity of the SMTC indicates the SSB periodicity of one or multiple neighbor cells measures using the respective SMTC. In one example, a periodicity of the SSB for each NTN neighboring cell is explicitly indicated by a value—e.g., a value 160 ms or 320 ms. In some embodiments, the neighbor cell configuration information is included in SIB19, SIB2, SIB3, SIB4, SIB5, and or in RRM measurement configurations.

In some embodiments, the UE can perform a random-access channel (RACH)-less handover (HO). In such embodiments, the UE can receive the RACH-less HO configuration which includes an indication of a Timing Advance Group (TAG) ID for a timing adjustment value (e.g., NTA, a measured value transmitted to the UE as part of a timing advance (TA) operation or command). In at least one embodiment, the UE can apply the timing adjustment value (NTA) of the indicated TAG ID for UL synchronization with a target cell during a RACH-less HO.

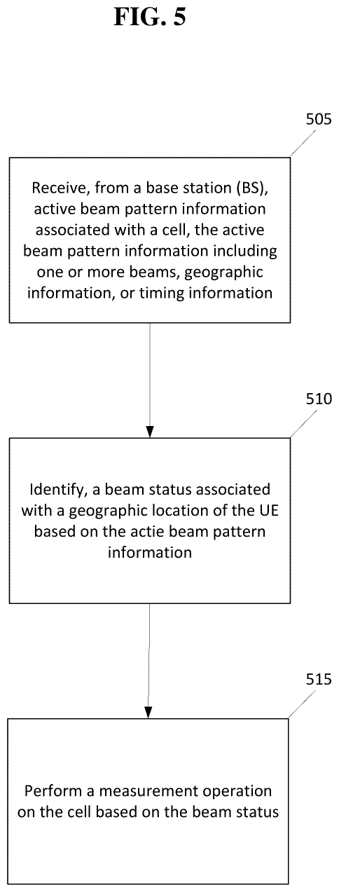

FIG. 5 shows an example process 500 for receiving an active beam pattern for measurement of a cell in accordance with an embodiment. For explanatory and illustration purposes, the example process 500 may be performed by an UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods.

Referring to FIG. 5, the process 500 may begin at operation 505. In operation 505, the UE receives, from a base station (BS), active beam pattern information for a cell. In at least one embodiment, the UE receives active beam pattern information for a serving cell—e.g., a cell the UE is currently physically located in. In at least one embodiment, the active beam pattern information can includes one or more beams, geographic information, or timing information. For example, the active beam pattern information includes information about a neighbor cell—e.g., a cell related to or otherwise having a relationship with the serving cell. In some embodiments, the neighbor cell can be a cell adjacent to the UE cell—e.g. to the serving cell. In at least one embodiment, the UE can receive the active beam pattern information from a base station (e.g., BS 101-103 as described with reference to FIG. 1). In such embodiments, the BS can identify a beam status for a geographic location associated with the UE. In some embodiments, the BS can generate the active beam pattern information associated with the cell. In some embodiment, the BS can generate the active beam pattern information to include the beam status, one or more beams, geographic information, or timing information. In at least one embodiment, the one or more beams of the active beam pattern information associated with the cell includes a list of beam indexes comprising one or more beams, each beam being identified by a respective beam identification (ID). In at least one embodiment, the BS can transmit the active beam pattern information to the UE as part of a measurement operation for the cell (e.g., serving cell or neighbor cell) based on generating the active beam pattern information. In at least some embodiments, the UE can determine if the cell is an NTN cell before receiving the active beam pattern information. In at least one embodiment, the UE can determine if the cell is an NTN cell (e.g., and whether the cell is barred for connectivity) based on receiving a bit from the BS. In one embodiment, this can be a cell barring bit as described with reference to FIG. 4—e.g., a cell barring bit included in SIB1 or MIB indicating whether the cell is an NTN cell and whether the cell is barred.

In at least one embodiment, the one or more beams of the active beam pattern information includes a list of beam indexes comprising the one or more beams, each beam being identified by a respective beam identification (ID). That is, the active beam pattern information includes a list of beams each identified by a respective beam ID as described with reference to FIG. 4. In some embodiments, the beams can be identified by an NR beam ID or a satellite beam ID. In other embodiments, the active beam pattern information includes a plurality of beam-level discontinuous transmission (DTX)/discontinuous reception (DRX) patterns, where each DTX/DRX pattern is associated with a logical ID. In at least one embodiment, a multi beam-level DTX/DRX pattern can include multiple active beam pattern configurations—e.g., the DTX/DRX pattern can include a first active beam and a second active beam during a respective duration for a geographic area. In embodiments DTX/DRX patterns are stored, the UE can use the parameters described with reference to FIG. 4.

In some embodiments, the active beam pattern information can include time information. In some embodiments, the time information can include at least one of an active periodicity, an active duration, or an offset for an active time of a beam associated with the active beam pattern information. In at least one embodiment, the timing information can include the parameters discussed with reference to FIG. 4. For example, the timing information can include a start time, an end time, an on-duration, a start offset, an active status, a periodicity, and/or two on-durations. In some embodiments, the active duration can refer to the start time and end time, the active status, or the on-duration.

In some embodiments, the active beam pattern information can include geographic information. In at least one embodiment, the geographic information can include a beam angle, location coordinate, or a distance of a beam of the active beam pattern information. For example, the location information can include a beam bore sight direction, a beam width (e.g., 3 dB beam width) indicated by an angle parameter, azimuth angle, a zenith angle, a leftmost elevation angle, a rightmost elevation angle, a radius, a reference coordinate, a center coordinate and radius, and/or polygon information as defined in TS 23.032 as described with reference to FIG. 4.

In operation 510, the UE can identify a beam status associated with a geographic location of the UE based on the active beam pattern information. That is, the UE can determine for a certain geographic area whether there are active beams (e.g., beams associated with common signaling or user traffic data) in a cell or whether the cell has no active beams. As described with reference to FIG. 4, the UE can predict an out of coverage duration when a cell has no active beams. In such embodiments, the UE can refrain from monitoring a physical downlink control channel (PDCCH). In other embodiments, the UE can determine a duration associated with the common beam signaling. In at least one embodiment, the UE can remain in an idle (e.g., RCC_IDLE) or inactive state (e.g., RCC_INACTIVE) during the duration associated with common beam signaling. In other embodiments, the UE can remain in an active state or connected state (e.g., RCC_CONNECTED) based on determining there is an active beam for user data during a duration the UE is in the cell. In at least some embodiments, the UE can determine the active time and the inactive time of a beam for the geographic location of the UE based on identifying an off state, an active state, or inactive state periodically for the geographic area. In other examples, the UE can determine the active time and the inactive time of the beam based on the BS (e.g., a network (NW)) activating or deactivating a DTX/DRX pattern as described with reference to FIG. 4. For example, the UE can receive a logical ID via radio resource controls (RRC) (e.g., in UE signaling) that indicates whether to activate or deactivate a DTX/DRX pattern. In other embodiments, the UE can receive the logical ID via medium access control (MAC) control element (CE). In such embodiments, the UE can receive the indication as a logical channel ID (LCID) or extended LCID (eLCID).

At operation 515, the UE can perform a measurement operation on the cell (e.g., serving cell or neighboring cell) based on identifying the active beam status. In at least one embodiment, the UE can determine an active time and an inactive time of a beam for the geographic location of the UE. In such embodiments, the UE can measure the cell during the active time of the beam and refrain from measuring the cell during the inactive time of the beam. In at least one embodiment, the UE can also communicate with a cell (e.g., serving cell) during the active time of the beam for the geographic location of the UE and refrain from communicating with the serving cell during the inactive time of the beam. That is, the active beam pattern information is associated with a plurality of frequencies, where one or more beams of the beam pattern information are associated with a respective frequency of the plurality of frequencies. As described with reference to FIG. 4, one or multiple DTX/DRX patterns are associated to each intra-frequency or inter-frequency (e.g., as indicated by an absolute radio-frequency channel number (ARFCN)) in a frequency list, or to each neighbor cell physical cell identification (PCI)/frequency in a neighbor cell frequency cell list. Upon receiving the active beam pattern information, the UE can use the information for measurement rules for cell reselection or neighbor measurements. As one example, the UE can determine an active time of the beam for a first frequency of the plurality of frequencies, determine an inactive time of the beam for the first frequency and prioritize the frequency for measurement during the active time of the beam and deprioritize the first frequency for measurement during the inactive time of the beam. In one example, the UE can have higher priorities for measurement when the active beams are associated with user data versus a lower priority for measurement when the active beams are associated with common signaling. Similarly, the UE can prioritize a neighbor cell where active beams are associated with user traffic data higher than a neighbor cell where active beams are associated with common signaling. In some embodiments, the UE can also use the active beam pattern information for a conditional handover operation (CHO)—e.g., the UE can receive the active beam pattern information for each CHO candidate cell and select a target CHO cell based on receiving the information as described with reference to FIG. 4. That is, in some embodiments, the UE can perform a cell reselection operation or execute a conditional handover (CHO) operation based at least in part on performing the measurement operation.

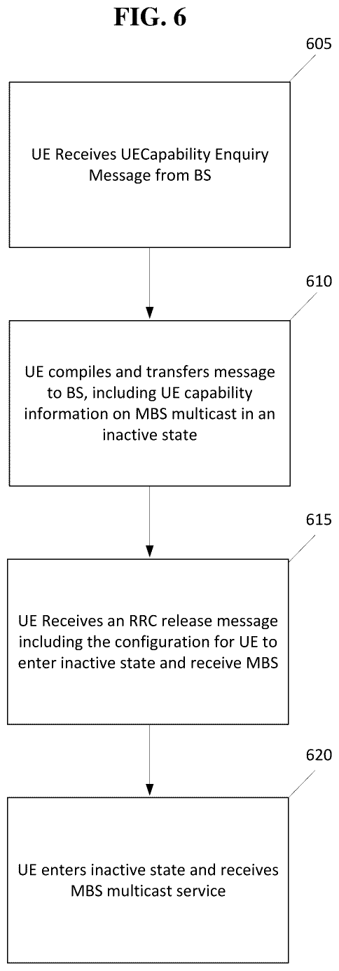

FIG. 6 shows an example process 600 UE MBS multicast in accordance with an embodiment. For explanatory and illustration purposes, the example process 600 may be performed by an UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods.

In some embodiments, new radio (NR) systems can utilize multicast/broadcast services MBS). In one embodiment, the NR systems can enable resource efficient delivery of MBS. For example, the MBS operation can include broadcasting communication services, having a same service and a same specific content data, simultaneously to all UEs in a geographical area—e.g., all UEs in the broadcast service area as defined in TS 23.247 are authorized to receive the simultaneous message. In at least one embodiment, the UE can receive broadcast communication services via broadcast session. In some embodiments, the UE can receive the broadcast communication service in an idle state (e.g., RRC_IDLE), in an inactive state (e.g., RRC_INACTIVE), and a connected state (RRC_CONNECTED).

In at least one embodiment, a dedicated set of UEs can receive a same service and a same specific content data during a multicast communication service. That is, not all UEs in a geographic area are authorized to receive the multicast service—e.g., not all UEs as defined in TS 23.247 may be authorized to receive the data. In at least one embodiment, a UE is delivered a multicast communication service via a multicast session. For example, a UE can receive a multicast communication service in a connected state (e.g., RCC_CONNECTED) via a precision time protocol (PTP) and/or a point-to-multipoint (PTM) delivery. In at least one embodiment, the UE can apply hybrid automatic repeat request (HARQ) feedback/retransmission to both PTP and PTM transmissions in the connected state. In some examples, the UE can receive the multicast communication service in an inactive state (e.g., RCC_INACTIVE) via PTM delivery.

In one embodiment, the UE can be configured to receive data of an MBS multicast session while in a connected or inactive state. For example, the UE can receive a multicast service by performing an MBS session join procedure (e.g., a session join procedure as specified in TS 23.247). In at least one embodiment, a node (e.g., gNB) determines whether the UE receives the MBS multicast session data in the connected or inactive state. In one embodiment, the gNB can transition the UE from a connected state to the inactive state via a release message (e.g., via an RRCRelease message). In some embodiments, the gNB can transition the UE from the inactive state to the connected state via a group notification or UE-specific paging. In one example, the gNB can send a configuration message (e.g., RRCReconfiguration) with relevant MBS configuration information for a multicast session to the UE when the UE is joined to an active multicast session in a connected state.

In other embodiments, the gNB can configure the UE to receive the multicast session in the inactive state. In such embodiments, gNB can transmit PTM configuration information via a release message (e.g., RRCRelease message). In some embodiments, the gNB can further transmit information about which multicast service(s) can be continued to be received in the inactive state. In one embodiment, the UE does not suspend multicast radio bearers (MRBs) of a multicast session indicated to be continued to be received in the inactive state. In at least one embodiment, a network or gNB can use multicast control channel (MCCH) if a cell supports updating PTM configuration or providing PTM configuration to UEs. In other embodiments, the network or gNB can use MCCH optionally. However, for UEs receiving MBS multicast services, additional specific capabilities are desired.

As described herein, UE specific capabilities are described for a UE to receive MBS multicast service. In at least one embodiment, the UE can be in a non-terrestrial network (NTN). In at least one embodiment, the UE can report its capability information as described herein. In at least one embodiment, process 600 reflects a UE receiving MBS multicast sessions in an inactive state.

Referring to FIG. 6, the process 600 may begin at operation 605. In operation 605, a UE receives a capability enquiry message (e.g., UECapabilityEnquiry message). In some embodiments, the UE receives the capability enquiry message from a base station (e.g., BS 101 as described with reference to FIG. 1).

In operation 610, the UE complies and transfers a capability information message (e.g., UECapabiltiyInformation message). In at least one embodiment, the capability information message includes UE capability information regarding an MBS multicast reception. In some embodiments, the UE capability information can indicate UE information regarding being in an inactive state (e.g., RRC_INACTIVE) and in an NTN network. In at least one embodiment, the UE capability information message can include one or multiple of the following capabilities, which can be per UE, per a frequency band, per frequency band combinations, without difference between frequency division duplex (FDD) and time division duplex (TDD), and without difference between F1 and F2 frequency ranges:
multicastInactiveNTN-r18, which indicates whether the UE supports multicast reception in the inactive state in a NTN. A UE supporting this feature can also indicate support of dynamicMulticastPCell-r17, and inactiveStateNTN-r17. In at least one embodiment, the following functional components make up the multicastInactiveNTN-r18
   Supports group-common PDCCH (physical downlink control channel)/PDSCH (physical downlink shared channel) for multicast with cyclic redundancy check (CRC) scrambled by multicast multicast control channel radio network temporary identifier (MCCH-RNTI)
   Supports group-common PDCCH/PDCSH for multicast with CRC scrambled by G-RNTI (e.g., a group radio network temporary identifier identifying dynamically scheduled point-to-multipoint (PTM) transmissions of multicast traffic channels (MTCH))
   Supports Downlink Control Information (DCI) format 4_0 with CRC scrambled with Multicast MCCH-RNTI for multicast MCCH
   Supports DCI format 4_1 with CRC scrambled G-RNTI for multicast MTCH
   Supports multicast MCCH change notification indication via DCI
   Supports common frequency resource (CFR) configuration for multicast
   Supports control resource set (CORESET) and common search space configuration for multicast
   Supports one G-RNTI for multicast reception
   Supports RRC configured slot-level repetition up to 8 for multicast MTCH
   Supports inter-lost time division multiplexing (TDM) group-common PDSCH for multicast MCCH and group-common PDSCH for multicast MTCH, or among group-common PDSCH for multicast MCCH, group-common PDSCH for multicast MTCH and other PDSCHs in different slots
   Supports up to 64 quadrature amplitude modulation (QAM64) for FR1/FR2
   Supports 120-bit length of packet data convergence protocol (PDCP) sequence number
   Supports Robust Header Compression (ROHC) profiles 0x0000 0x0001, 0x0002
   Supports 4 ROHC header compression context sessions
   Supports unacknowledged mode (UM) MRB with 12-bit length of RLC sequence number
   Supports UM MRB with 6-bit length of RLC sequence numbers
   Supports long DRX cycle for MBS multicast reception as specified in TS38.321.
HARQ-RTT-TimerDL-ForNTN-MulticastMBS-NTN-r18, which indicates whether the UE supports the NTN extension of the DRX-HARQ-RTT-TimerDL-PTM and/or DRX-HARQ-RTT-TimerDL for MBS Multicast DRX in the inactive state (e.g., RRC_INACTIVE). A UE supporting this feature shall also indicate the support of inactiveStateNTN-r17, dynamicMulticastPCell-r17, and at least one of the following features: ack-NACK-FeedbackForMulticast-r17, ack-NACK-FeedbackForSPS-Multicast-r17, nack-OnlyFeedbackForMulticast-r17, nack-OnlyFeedbackForSPS-Multicast-r17.
PTM-HARQ-RTT-TimerDL-ForNTN-MulticastMBS-NTN-r18, which indicates whether the UE supports the NTN extension of the DRX-HARQ-RTT-TimerDL-PTM and/or DRX-HARQ-RTT-TimerDL for MBS Multicast DRX in the inactive state (e.g., RRC_INACTIVE.) A UE supporting this feature shall also indicate the support of inactiveStateNTN-r17, dynamicMulticastPCell-r17, and at least one of the following features: ack-NACK-FeedbackForMulticast-r17, ack-NACK-FeedbackForSPS-Multicast-r17, nack-OnlyFeedbackForMulticast-r17, nack-OnlyFeedbackForSPS-Multicast-r17.
ThresholdBasedMulticastResumeNTN-r18, which indicates whether the UE supports RRC connection resumption triggering due to the reception quality below the configured threshold, specified by thresholdMBS-List-r18 in TS 38.331. A UE supporting this feature shall also indicate support of multicastInactive-r18 and inactiveStateNTN-r17

At operation 615, the UE can receive an RRC message from the BS. For example, the UE can receive an RRC message (e.g., RRC release message) that includes configuration information for the UE to enter the inactive state and receive the MBS while in the inactive state.

At operation 620, the UE can enter the inactive state (e.g., RRC_INACTIVE) and receive the MBS multicast service. In one embodiment, the UE is configured to receive the MBS multicast service based on receiving the release message from the BS. In one embodiment, the UE receives the information according to a configuration indicated in the release message.

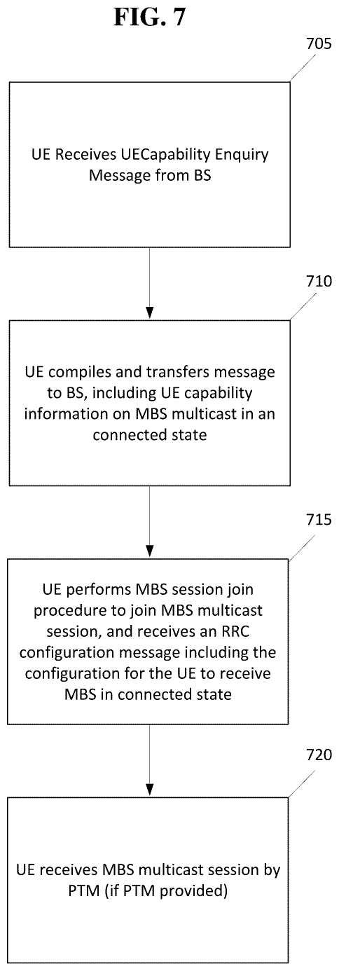

FIG. 7 shows an example process 700 UE MBS multicast in accordance with an embodiment. For explanatory and illustration purposes, the example process 700 may be performed by an UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods. In at least one embodiment, process 700 can illustrate a UE reporting its capabilities and receiving a MBS multicast session in a connected sate (e.g., RCC_CONNECTED).

Referring to FIG. 7, the process 700 may begin in operation 705. In operation 705, a UE receives a capability enquiry message (e.g., UECapabilityEnquiry message). In some embodiments, the UE receives the capability enquiry message from a base station (e.g., BS 101 as described with reference to FIG. 1).

In operation 710, the UE complies and transfers a capability information message (e.g., UECapabiltiyInformation message). In at least one embodiment, the capability information message includes UE capability information regarding an MBS multicast reception—e.g., PTM-RetransmissionNTN). In some embodiments, the UE capability information can indicate UE information regarding being in a connected state (e.g., RRC_CONNECTED) and in an NTN network. In at least one embodiment, the UE capability information message can include one or multiple of the capabilities described with reference to FIG. 6, which can be per UE, per a frequency band, per frequency band combinations, without difference between frequency division duplex (FDD) and time division duplex (TDD), and without difference between F1 and F2 frequency. In some examples, the UE capability information can include:
ptm-RetransmissionNTN-r18, which indicates whether the UE supports starting HARQ-RTT-TimerDL-PTM-NTN and DRX-RetransmissionTimerDL-PTM during multicast reception in a connected state (e.g., RRC_CONNECTED state as specified in TS 38.321), when HARQ feedback is disabled for the UE. A UE supporting this feature shall also indicate support of dynamicMulticastPCell-r17, harq-RTT-TimerDL-ForNTN-MulticastMBS-r17, and at least one of the following features: ack-NACK-FeedbackForMulticast-r17, ack-NACK-FeedbackForSPS-Multicast-r17, nack-OnlyFeedbackForMulticast-r17, nack-OnlyFeedbackForSPS-Multicast-r17

At operation 715, the UE can perform MBS join procedure to join a MBS multicast session. In some embodiments, the UE can receive a reconfiguration message (e.g., RRC reconfiguration message) that includes the configuration information for the UE to receive the MBS multicast session in a connected state.

At operation 720, the UE can receive the MBS multicast session by PTM. In at least one embodiment, the UE can receive the MBS multicast session by PTM if a PTM configuration is provided—e.g., the PTM configuration is received from the BS.

Various embodiments in the disclosure provides a mechanism for a UE to receive active beam pattern information resulting in more resource efficient allocation. For example, the UE can use the active beam pattern information (e.g., an index of beams associated with the active beam pattern) to measure a neighboring cell based on receiving the active beam pattern information. Accordingly, the UE can perform measurement operations when the neighboring cell is active, based on receiving the active beam status information.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a processor configured to:
receive, from a base station (BS), active beam pattern information associated with a cell, wherein the beam pattern information includes one or more beams, geographic information, or timing information;
identify a beam status associated with a geographic location of the UE based on the active beam pattern information; and
perform a measurement operation on the cell based on the active beam status.

2. The UE of claim 1, wherein the one or more beams of the active beam pattern information associated with the cell includes a list of beam indexes comprising the one or more beams, each beam being identified by a respective beam identification (ID).

3. The UE of claim 1, wherein the processor is further configured to:
determine an active time and an inactive time of a beam for the geographic location of the UE based on the active beam pattern information.

4. The UE of claim 3, wherein to perform the measurement operation on the cell, the processor is further configured to:
measure the cell during the active time of the beam; and
refrain from measuring the cell during the inactive time of the beam.

5. The UE of claim 3, wherein the processor is further configured to:
communicate with the BS during the active time of the beam for the geographic location of the UE; and
refrain from communicating with the BS during the inactive time of the beam for the geographic location of the UE.

6. The UE of claim 1, wherein the active beam pattern information is associated with a plurality of frequencies, and wherein one or more beams indicated by the active beam pattern information are associated with a respective frequency of the plurality of frequencies.

7. The UE of claim 6, wherein the processor is further configured to:
determine an active time of the beam for a first frequency of the plurality of frequencies;
determine an inactive time of the beam for the first frequency of the plurality of frequencies;
prioritize the first frequency for measurement during the active time of the beam; and
deprioritize the first frequency for measurement during the inactive time of the beam.

8. The UE of claim 1, wherein the timing information of the active beam pattern information includes at least one of a periodicity, a duration, or an offset for an active time of a beam associated with the beam pattern information.

9. The UE of claim 1, wherein the geographic information of the active beam pattern information includes at least one of a beam angle, location coordinate, or distance of a beam associated with the active beam pattern information.

10. The UE of claim 1, wherein the processor is further configured to:
perform a cell reselection operation or execute a conditional handover (CHO) operation based at least in part on performing the measurement operation.

11. A base station (BS) for facilitating communication in a wireless network, the BS comprising:
a processor configured to:
identify a beam status for a geographic location associated with a user equipment (UE); and
generate an active beam pattern information associated with a cell associated with the UE, wherein the active beam pattern information includes the beam status, one or more beams, geographic information, or timing information; and
a transceiver operably coupled to the processor, the transceiver configured to:
transmit the active beam pattern information to a user equipment (UE) that is used for a measurement operation for the cell based at least in part on generating the active beam pattern information.

12. The BS of claim 11, wherein the one or more beams of the active beam pattern information associated with the cell includes a list of beam indexes comprising the one or more beams, each beam being identified by a respective beam identification (ID).

13. The BS of claim 11, wherein:
the active beam pattern information is associated with a plurality of frequencies; and
one or more beams indicated by the active beam pattern information are associated with a respective frequency of the plurality of frequencies.

14. The BS of claim 11, wherein the timing information of the active beam pattern information includes at least one of a periodicity, a duration, or an offset for an active time of a beam associated with the beam pattern information.

15. The BS of claim 11, wherein the geographic information of the active beam pattern information includes at least one of a beam angle, location coordinate, or distance of a beam associated with the active beam pattern information.

16. A method performed by a user equipment (UE) for facilitating communication in a wireless network, comprising:
receiving, from a base station (BS), active beam pattern information associated with a cell, wherein the beam pattern information includes one or more beams, geographic information, or timing information;
identify a beam status associated with a geographic location of the UE based on the active beam pattern information; and
perform a measurement operation on the cell based on the active beam status.

17. The method of claim 16, wherein the one or more beams of the active beam pattern information associated with the cell includes a list of beam indexes comprising the one or more beams, each beam being identified by a respective beam identification (ID).

18. The method of claim 16, further comprising:
determining an active time and an inactive time of a beam for the geographic location of the UE based on the active beam pattern information.

19. The method of claim 18, wherein the performing the measurement operation comprises:
measuring the cell during the active time of the beam; and
refraining from measuring the cell during the inactive time of the beam.

20. The method of claim 19, further comprising:
communicating with the BS during the active time of the beams for the geographic location of the UE; and
refraining from communicating with the BS during the inactive time of the beam for the geographic location of the UE.
